(19) United States
(12) Patent Application Publication
(10) Pub. No.: US 2024/0113649 A1
(43) Pub. Date: Apr. 4, 2024

(54) ELECTRONIC CLUTCH INCLUDING ECO OPERATING MODE

(71) Applicant: MILWAUKEE ELECTRIC TOOL CORPORATION, Brookfield, WI (US)

(72) Inventors: Austin Gaspar, Maple Valley, WA (US); Robert Keys, Pewaukee, WI (US); Bradley A. Seymour, Wauwatosa, WI (US)

(21) Appl. No.: 18/474,424

(22) Filed: Sep. 26, 2023

Related U.S. Application Data
(60) Provisional application No. 63/416,713, filed on Oct. 17, 2022.
(60) Provisional application No. 63/410,305, filed on Sep. 27, 2022.

(51) Int. Cl. H02P 27/08; B25F 5/00; H02K 7/14; H02K 11/33

(52) U.S. Cl. CPC H02P 27/085; B25F 5/001; H02K 7/145; H02K 11/33

(57) ABSTRACT

A power tool includes a motor, a speed sensor configured to sense a speed of the motor, and a controller connected to the motor and the speed sensor. The controller is configured to provide power to the motor, determine a first command based on the speed of the motor, determine, while in a first operating mode, whether the first command is greater than or equal to a first limit, determine, while in the first operating mode, a PWM duty cycle ratio based on the first limit, determine, while in a second operating mode, whether a parameter command is greater than or equal to a parameter limit, while in the second operating mode and when the parameter command is greater than or equal to the parameter limit, the PWM duty cycle ratio based on the parameter limit, and drive the motor based on the PWM duty cycle ratio.

### RELATED APPLICATIONS

This application claims the benefit of U.S. Provisional Patent Application No. 63/416,713, filed Oct. 17, 2023, and U.S. Provisional Patent Application No. 63/410,305, filed Sep. 27, 2022, the entire content of each of which is hereby incorporated by reference.

### SUMMARY

Embodiments described herein provide systems and methods for switching between operating modes of an electronic clutch in a power tool.

Power tools having an electronic clutch described herein include a motor, a power switch, a speed sensor configured to sense a speed of the motor, and a controller connected to the power switch, the motor, and the speed sensor. The controller is configured to provide, in response to actuation of the power switch, power to the motor, determine a first parameter command based on the speed of the motor, determine, while in a first operating mode, whether the first parameter command is greater than or equal to a first parameter limit, and determine, while in the first operating mode and when the first parameter command is greater than or equal to the first parameter limit, a pulse width modulation (“PWM”) duty cycle ratio based on the first parameter limit. The controller is further configured to determine, while in a second operating mode, whether a second parameter command is greater than or equal to a second parameter limit, determine, while in the second operating mode and when the second parameter command is greater than or equal to the parameter limit, the PWM duty cycle ratio based on the second parameter limit, and drive the motor based on the PWM duty cycle ratio.

In some aspects, the first parameter command is one of a first torque command or a first current command, and the second parameter command is one of a second torque command or a second current command.

In some aspects, the controller is further configured to determine, based on the speed of the motor and a speed command signal, the first parameter command, compare the first parameter command to a torque-current look-up table, determine, based on the comparison, an electric current value to provide to the motor, and provide the electric current value to the motor to drive the motor.

In some aspects, the power tool further includes a current sensor configured to provide current signals indicative of a current of the motor, and the controller is further configured to receive, from the current sensor, the current signals indicative of the current of the motor, determine the PWM duty cycle ratio based on the current of the motor and the electric current value, and drive the motor according to the PWM duty cycle ratio.

In some aspects, the controller is further configured to control, in response to actuation of the power switch, the motor according to the first operating mode for a third period of time.

In some aspects, the controller is further configured to limit, in response to the third period of time being satisfied, a motor current provided to the motor for a fourth period of time.

In some aspects, the controller is further configured to control, in response to the fourth period of time being satisfied, the motor according to the first operating mode.

In some aspects, the controller is further configured to determine, while in the first operating mode and when the first parameter command is less than the first parameter limit, the PWM duty cycle ratio based on the first parameter command, and determine, while in the second operating mode and when the second parameter command is less than the second parameter limit, the PWM duty cycle ratio based on the second parameter command.

Methods for operating a power tool including an electronic clutch described herein include providing, in response to actuation of a power switch, power to a motor, determining a first parameter command based on a speed of the motor, determining, while in a first operating mode, whether the first parameter command is greater than or equal to a first parameter limit, determining, while in the first operating mode and when the first parameter command is greater than or equal to the first parameter limit, a PWM duty cycle ratio based on the first parameter limit, determining, while in a second operating mode, whether a second parameter command is greater than or equal to a second parameter limit, determining, while in the second operating mode and when the second parameter command is greater than or equal to the second parameter limit, the PWM duty cycle ratio based on the second parameter limit, and drive the motor based on the PWM duty cycle ratio.

In some aspects, the first parameter command is one of a first torque command or a first current command, and the second parameter command is one of a second torque command or a second current command.

In some aspects, the method further includes determining, based on the speed of the motor and a speed command signal, the first parameter command, comparing the first parameter command to a torque-current look-up table, determining, based on the comparison, an electric current value to provide to the motor, and providing the electric current value to the motor to drive the motor.

In some aspects, the method further includes receiving current signals indicative of the current of the motor, determining the PWM duty cycle ratio based on the current of the motor and the electric current value, and driving the motor according to the PWM duty cycle ratio.

In some aspects, the method further includes controlling, in response to actuation of the power switch, the motor according to the first operating mode for a third period of time, limiting, in response to the third period of time being satisfied, a motor current provided to the motor for a fourth period of time, and controlling, in response to the fourth period of time being satisfied, the motor according to the first operating mode.

In some aspects, the method further includes determining, while in the first operating mode and when the first parameter command is less than the first parameter limit, the PWM duty cycle ratio based on the first parameter command, and determining, while in the second operating mode and when the second parameter command is less than the second parameter limit, the PWM duty cycle ratio based on the second parameter command.

Power tools having an electronic clutch described herein include a motor, a speed sensor configured to sense a speed of the motor, a current sensor configured to sense a current of the motor, and a controller connected to the motor, the speed sensor, and the current sensor. The controller is configured to drive, while in a first operating mode, the motor based on the speed of the motor and a torque limit value, receive a user input indicative of a request to change from the first operating mode to a second operating mode, and drive, while in the second operating mode, the motor based on the speed of the motor and the current of the motor.

In some aspects, the controller is further configured to determine, while in the first operating mode, a torque command based on a speed command and the speed of the motor, determine, while in the first operating mode, whether the torque command is greater than or equal to the torque limit value, determine, while in the first operating mode and when the torque command is greater than or equal to the torque limit value, a PWM duty cycle ratio based on the first torque limit, and drive the motor based on the PWM duty cycle ratio.

In some aspects, the controller is further configured to determine, while in the second operating mode, a current command based on a speed command, the speed of the motor, and the current of the motor, determine, while in the second operating mode, whether the current command is greater than or equal to a current threshold, determine, while in the second operating mode and when the current command is greater than or equal to the current threshold, a PWM duty cycle ratio based on the current threshold, and drive the motor based on the PWM duty cycle ratio.

In some aspects, the controller is further configured to determine, while in the second operating mode and when the current command is less than the current threshold, the PWM duty cycle ratio based on the speed of the motor and the current of the motor, and drive the motor based on the PWM duty cycle ratio.

In some aspects, while in the first operating mode, the controller is further configured to determine, based on the speed of the motor and a speed command signal, a torque command, compare the torque command to a torque-current look-up table, determine, based on the comparison, an electric current value to provide to the motor, and provide the electric current value to the motor to drive the motor.

In some aspects, the controller is further configured to control, in response to actuation of a power switch, the motor according to the first operating mode for a first period of time, limit, in response to the first period of time being satisfied, a motor current provided to the motor for a second period of time, and control, in response to the second period of time being satisfied, the motor according to the first operating mode.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects will become apparent by consideration of the following detailed description and accompanying drawings.

### BRIEF DESCRIPTION OF THE DRAWINGS

FIG. 1A illustrates a left perspective view of a pump, in accordance with embodiments described herein.

FIG. 1B illustrates a right perspective view of the pump of FIG. 1A.

FIG. 1C illustrates a cross-sectional perspective view of the pump along line 3-3 of FIG. 1A.

FIG. 1D illustrates a cross-sectional plan view of the pump along line 4-4 of FIG. 1A.

FIG. 2 illustrates a block diagram of a controller for the power tool of FIG. 1 in accordance with embodiments described herein.

FIG. 3 illustrates a block diagram of a control architecture implemented by the controller of FIG. 2 in accordance with embodiments described herein.

FIG. 4 illustrates a block diagram of a control block included in the control architecture of FIG. 3 in accordance with embodiments described herein.

FIG. 5 illustrates a block diagram of another control block included in the control architecture of FIG. 3 in accordance with embodiments described herein.

FIGS. 6A-6B illustrate graphs for measuring the absorption energy of a motor in accordance with embodiments described herein.

FIG. 7 illustrates a state machine block diagram for an electronic clutch in accordance with embodiments described herein.

FIG. 8 illustrates a block diagram of a speed controller in accordance with embodiments described herein.

FIG. 9 illustrates a block diagram of a look-up table operation in accordance with embodiments described herein.

FIG. 10 illustrates a block diagram of a bus current controller in accordance with embodiments described herein.

FIG. 11 illustrates a block diagram of a method performed by the controller of FIG. 2 in accordance with embodiments described herein.

FIGS. 12A-12B illustrate a block diagram of another method performed by the controller of FIG. 2 in accordance with embodiments described herein.

FIG. 13 illustrates a block diagram of another method performed by the controller of FIG. 2 in accordance with embodiments described herein.

FIG. 14 illustrates another block diagram of a control block included in the control architecture of FIG. 3 while in a second operating mode, in accordance with embodiments described herein.

FIG. 15 illustrates a block diagram of another method performed by the controller of FIG. 2 in accordance with embodiments described herein.

### DETAILED DESCRIPTION

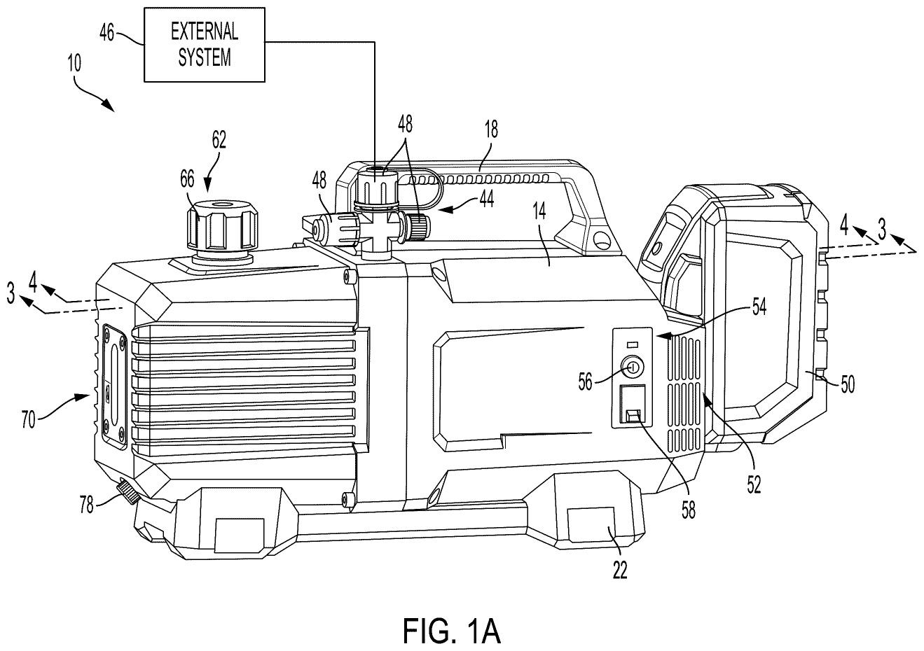

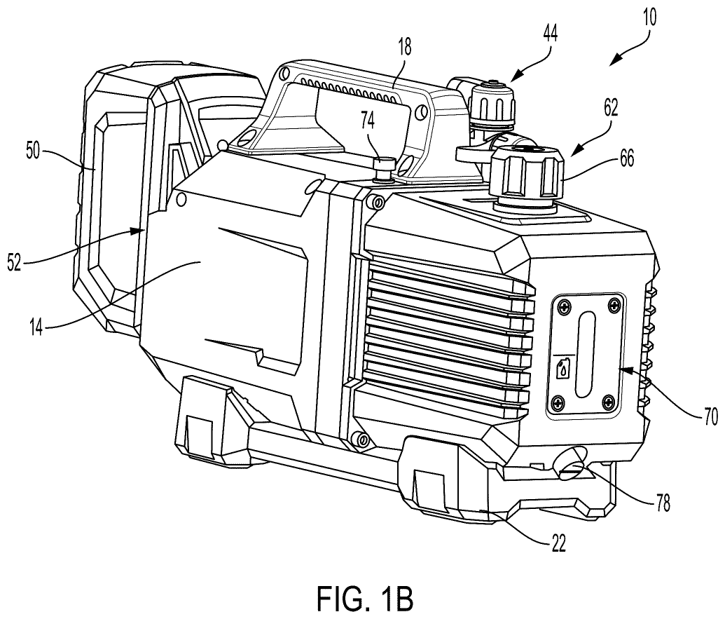

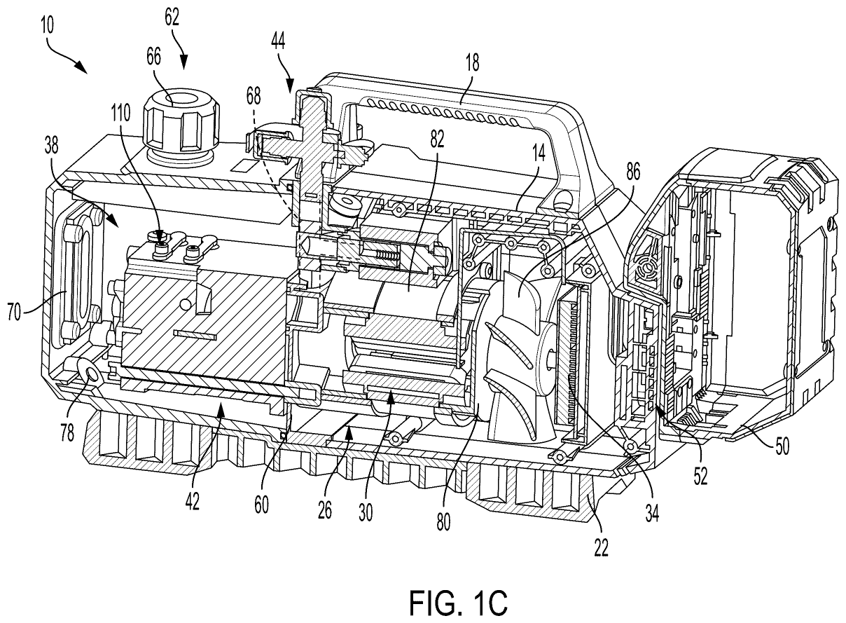

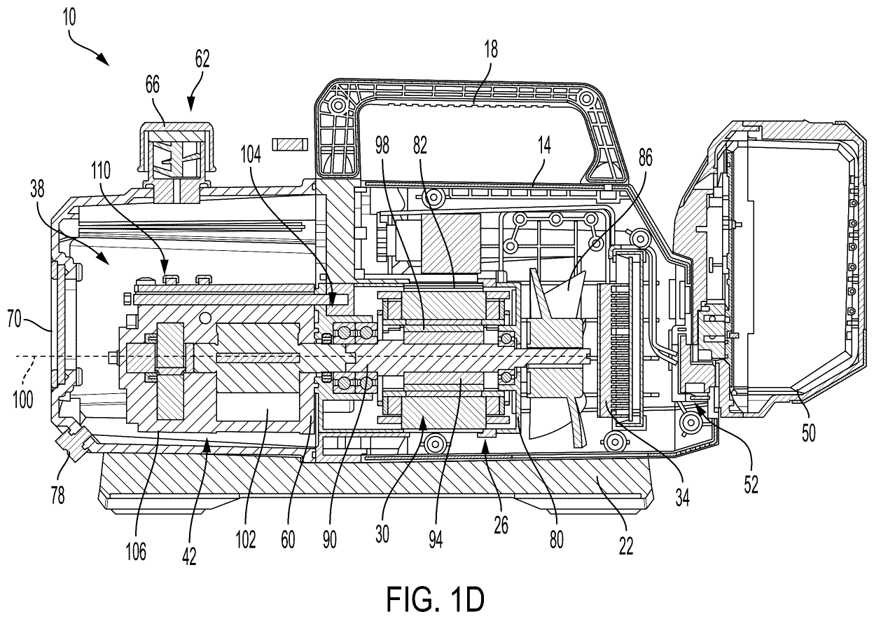

FIGS. 1A-1D illustrate a pump 10 (e.g., a vacuum pump) including a housing 14, a handle 18 coupled to an upper portion of the housing 14, and a base 22 coupled to a lower portion of the housing 14 to support the pump 10 relative to the ground. The housing 14 defines an internal cavity (see FIG. 1C) that has a first chamber 26 that houses, protects, and/or conceals a motor assembly 30, an electronic control unit 34, and other electronic components. The internal cavity of the housing 14 also defines a second chamber (e.g., a compression chamber 38) that houses a pump assembly 42.

With reference to FIG. 1A, an inlet 44 is positioned on an upper portion of the housing 14 and is in communication with the pump assembly 42. The inlet 44 is fluidly connected to a hose 40 that connects the pump 10 to an external system 46 (e.g., an air conditioning system, a refrigeration system, etc.). In the illustrated embodiment, the inlet 44 includes multiple connection ports 48 that are sized to connect to the hose 40 of the external system 46. For example, the connection ports 48 may have various sizes (e.g., ½ inch, ¼ inch, etc.).

A battery pack 50 is removably coupled to an end portion of the housing 14 via a battery pack interface 52 (e.g., a battery receptacle). The battery pack 50 provides electrical current to the motor assembly 30 that drives the pump assembly 42 to remove or evacuate material such as air, gas, and non-condensables (e.g., water vapor) from the external system 46. The pump 10 includes a control panel 54 on a sidewall of the housing 14. In the illustrated embodiment, the control panel 54 includes a power switch 56 that selectively activates the pump 10 and a Universal Serial Bus (“USB”) port 58. In some embodiments, an external display may be connected to the USB port 58 to display information related to the operation of the pump 10 (e.g., battery life remaining, micron gauge, etc.). In other embodiments, the control panel 54 may include a display (e.g., an LCD display).

With reference to FIG. 1C, the compression chamber 38 is sealed relative to the first chamber 26 via a partition wall 60 so the compression chamber 38 can hold lubrication fluid (e.g., oil). In the illustrated embodiment, the partition wall 60 defines a fluid pathway 68 that extends between the inlet 44 and the pump assembly 42. The lubrication fluid positioned within the compression chamber 38 is used to lubricate and cool the pump assembly 42 during operation of the pump 10.

With reference to FIG. 1B, the compression chamber 38 further includes a fluid port 62 having a removable cap 66, a fluid gauge 70 positioned on a sidewall of the housing 14, a release valve 74 positioned on the upper portion of the housing 14, and a fluid drain valve 78 positioned at the bottom of the compression chamber 38 adjacent the base 22. In the illustrated embodiment, a user may remove the removable cap 66 to fill the compression chamber 38 with lubrication fluid via the fluid port 62. The fluid port 62 and the removable cap 66 may also function as an exhaust during operation of the pump 10. The fluid gauge 70 may be transparent to allow a user to determine the amount of lubrication fluid that is held within the compression chamber 38. Also, the fluid drain valve 78 allows the user to drain the lubrication fluid from the compression chamber 38.

With reference to FIG. 1D, the motor assembly 30 is positioned within the first chamber 26 and is coupled to the partition wall 60 via a support bracket 80. The motor assembly 30 includes a motor 82 and a fan 86 driven by the motor 82. In the illustrated embodiment, the motor 82 is a brushless direct current (“BLDC”) motor that has a motor shaft 90 having a first end coupled to the fan 86 and a second end coupled to the pump assembly 42, a rotor 94 coupled to the motor shaft 90, and a stator 98 surrounding the rotor 94. During operation of the motor 82, an electrical current flows through coils of the stator 98 to produce a magnetic field around the rotor 94, which causes the motor shaft 90 to rotate about a drive axis 100 and drive the pump assembly 42. The fan 86 is positioned between the electronic control unit 34 and the motor assembly 30. The fan 86 removes heat from the electronic control unit 34 and provides air to the motor assembly 30 to prevent overheating of each of the electronic control unit 34 and the motor assembly 30. Although the motor 82 of the illustrated embodiment is a BLDC motor, in other embodiments, the motor 82 may alternatively be a brushed direct current motor or any other type of DC motor.

With reference to FIG. 1D, the pump assembly 42 is a two-stage pump that has a first pump chamber 102 and a second pump chamber 106 in series with the first pump chamber 102. The first pump chamber 102 has a pump inlet 104 in communication with the fluid pathway 68. The first pump chamber 102 is in fluid communication with the second pump chamber 106. The second pump chamber 106 has a pump outlet 110 that releases the pressure from the pump assembly 42 to the compression chamber 38. Specifically, the pump chambers 102, 106 create low-pressure zones within the pump assembly 42, which draws material out of the external system 46 (see FIG. 1A) and into the pump assembly 42. The evacuated material is transferred from the first pump chamber 102 to the second pump chamber 106, at which point the evacuated material is discharged into the compression chamber 38 via the second pump outlet 110. In the illustrated embodiment, the second pump outlet 110 includes a valve (e.g., a reed valve, etc.) that selectively releases the evacuated material into the compression chamber 38 before being released from the pump 10 through the exhaust (e.g., via the cap 66) of the compression chamber 38. Although the illustrated pump assembly 42 is a two-stage pump (e.g., has first and second pump chambers), in other embodiments, the pump assembly 42 may only include a single stage or chamber.

During operation, a user may attach the battery pack 50 to the battery pack interface 52 of the pump 10, and fluidly connect the external system 46 to the vacuum pump 10 via the inlet 44 (e.g., with the hose 40). The user may activate the pump 10 with the control panel 54 (e.g., by depressing the power switch 56) to activate the motor assembly 30 and begin evacuating material from the external system 46. When the vacuum pump 10 is activated, the first and second pump chambers 102, 106 create a low-pressure zone to evacuate material from the external system 46.

While FIG. 1A illustrates a vacuum pump, it is contemplated that the electronic clutch described herein may be used with multiple types of other power tools. For example, the electronic clutch may be implemented in rotational tools such as drills, drivers, powered screw drivers, powered ratchets, grinders, right angle drills, rotary hammers, pipe threaders, or another type of power tool that experiences rotation about an axis (e.g., a longitudinal axis). In some embodiments, the electronic clutch is implemented in a power tool that experiences translational movement along a longitudinal axis, such as reciprocal saws, chainsaws, pole-saws, circular saws, cut-off saws, die-grinder, and table saws.

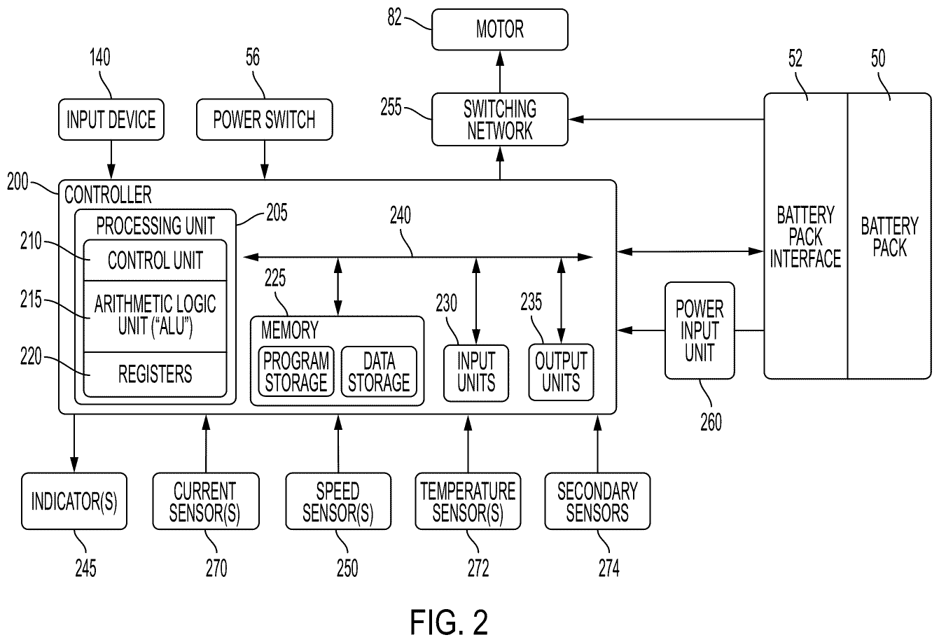

A controller 200 for the pump 10 is illustrated in FIG. 2. The controller 200 is electrically and/or communicatively connected to a variety of modules or components of the pump 10. For example, the illustrated controller 200 is connected to indicators 245, a current sensor 270, a speed sensor 250, a temperature sensor 272, secondary sensor(s) 274 (e.g., a voltage sensor, an accelerometer, etc.), the power switch 56, a power switching network 255, and a power input unit 260.

The controller 200 includes a plurality of electrical and electronic components that provide power, operational control, and protection to the components and modules within the controller 200 and/or pump 10. For example, the controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 2), and is implemented using a known computer architecture (e.g., a modified Harvard architecture, a von Neumann architecture, etc.). The processing unit 205, the memory 225, the input units 230, and the output units 235, as well as the various modules connected to the controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the pump 10 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 includes additional, fewer, or different components.

The controller 200 drives the motor 82 in response to actuation of the power switch 56. In some embodiments, the controller 200 controls the power switching network 255 (e.g., a FET switching bridge) to drive the motor 82. For example, the power switching network 255 may include a plurality of high side switching elements (e.g., FETs) and a plurality of low side switching elements. The controller 200 may control each FET of the plurality of high side switching elements and the plurality of low side switching elements to drive each phase of the motor 82. For example, the power switching network 255 may be controlled to more quickly deaccelerate the motor 82. In some embodiments, the controller 200 monitors a rotation of the motor 82 (e.g., a rotational rate of the motor 82, a velocity of the motor 82, a position of the motor 82, and the like) via the speed sensor 250.

The indicators 245 are also connected to the controller 200 and receive control signals from the controller 200 to turn on and off or otherwise convey information based on different states of the pump 10. The indicators 245 include, for example, one or more light-emitting diodes (LEDs), or a display screen. The indicators 245 can be configured to display conditions of, or information associated with, the pump 10. For example, the indicators 245 can display information relating to an operational state of the pump 10, such as a mode or speed setting (e.g., suction pressure). The indicators 245 may also display information relating to a fault condition, or other abnormality of the pump 10. In addition to or in place of visual indicators, the indicators 245 may also include a speaker or a tactile feedback mechanism to convey information to a user through audible or tactile outputs. In some embodiments, the indicators 245 display information related to a braking operation or a clutch operation (e.g., an electronic clutch operation) of the controller 200. For example, one or more LEDs are activated when the controller 200 is performing a clutch operation.

The battery pack interface 52 is connected to the controller 200 and is configured to couple with a battery pack 50. The battery pack interface 52 includes a combination of mechanical (e.g., a battery pack receiving portion) and electrical components configured to and operable for interfacing (e.g., mechanically, electrically, and communicatively connecting) the pump 10 with the battery pack 50. The battery pack interface 52 is coupled to the power input unit 260. The battery pack interface 52 transmits the power received from the battery pack 50 to the power input unit 260. The power input unit 260 includes active and/or passive components (e.g., voltage step-down controllers, voltage converters, rectifiers, filters, etc.) to regulate or control the power received through the battery pack interface 52 and to the controller 200. In some embodiments, the battery pack interface 52 is also coupled to the power switching network 255. The operation of the power switching network 255, as controlled by the controller 200, determines how power is supplied to the motor 82.

The current sensor 270 senses a current provided by the battery pack 50, a current associated with the motor 82, or a combination thereof. In some embodiments, the current sensor 270 senses at least one of the phase currents of the motor. The current sensor 270 may be, for example, an inline phase current sensor, a pulse-width-modulation-center-sampled inverter bus current sensor, or the like. The speed sensor 250 senses a speed of the motor 82. The speed sensor 250 may include, for example, one or more Hall effect sensors. In some embodiments, the temperature sensor 272 senses a temperature of the power switching network 255, the battery pack 50, the motor 82, or a combination thereof.

The input device 140 is operably coupled to the controller 200 to, for example, select a forward mode of operation, a reverse mode of operation, a torque setting for the pump 10, and/or a speed setting for the pump 10 (e.g., using torque and/or speed switches), etc. In some embodiments, the input device 140 includes a combination of digital and analog input or output devices required to achieve a desired level of operation for the pump 10, such as one or more knobs, one or more dials, one or more switches, one or more buttons, a touch screen, etc. A user may operate the input device 140 to adjust an operating mode of the pump 10, such as entering an Idle Mode, a Full Power Mode, and an “Eco-Mode”, described below in more detail.

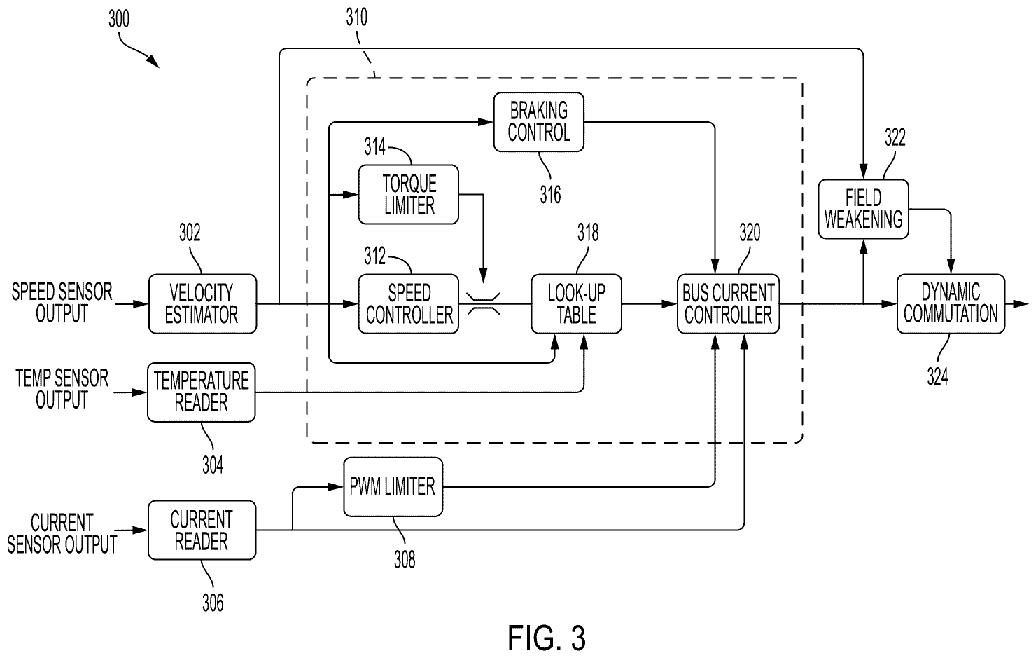

The controller 200 is configured to monitor operating characteristics of the pump 10 to drive the motor 82. For example, FIG. 3 provides a block diagram of a control architecture 300 implemented by the controller 200. The control architecture 300 includes, among other things, a velocity estimator module 302, a temperature reader module 304, a current reader module 306, a pulse width modulation (PWM) limiter 308, a field weakening module 322, a dynamic commutation module 324, and a driving algorithm 310. The driving algorithm 310 includes, among other things, software and applications used to drive the motor 82, such as a speed controller 312, a torque limiter module 314, a braking control module 316, look-up table 318, and a bus current controller 320. The control architecture 300 of FIG. 3 is merely an example. In other embodiments, functions of the various modules and controllers may be combined or separated into additional modules.

The velocity estimator module 302 receives speed signals from the speed sensor 250 indicative of a speed or velocity of the motor 82. The velocity estimator module 302 converts the received speed signal to a speed value or velocity value that is then provided to the driving algorithm 310. In some embodiments, the speed signals from the speed sensor 250 are provided directly to the driving algorithm 310.

In some embodiments, the velocity estimator module 302 determines (or estimates) the speed or velocity of the motor 82 based on current signals from the current sensor 270. For example, the velocity estimator module 302 converts received current signals to a speed value or velocity value that is then provided to the driving algorithm 310. In some embodiments, the velocity estimator module 302 determines the speed or velocity of the motor 82 based on a voltage of the motor 82 (as received from a voltage sensor included in the secondary sensors 274).

The temperature reader module 304 receives temperature signals from the temperature sensor 272 indicative of a temperature of the pump 10. For example, the temperature reader module 304 receives temperature signals indicative of a temperature of the gearbox 285. In some embodiments, the temperature reader module 304 receives temperature signals indicative of a temperature of the motor 82 and/or the power switching network 255. The temperature reader module 304 converts the temperature signal to a temperature value that is then provided to the driving algorithm 310. In some embodiments, the temperature signals from the temperature sensor 272 are provided directly to the driving algorithm 310. The temperature signals may be used by the driving algorithm 310 to improve torque repeatability over a wide temperature range.

The current reader module 306 receives current signals from the current sensor 270 indicative of the current of the motor 82. The current reader module 306 converts the received current signal to a current value (e.g., a voltage indicative of the current) that is then provided to the driving algorithm 310. In some embodiments, the current signals from the current sensor 270 are provided directly to the driving algorithm 310.

The PWM limiter 308 receives the current of the motor 82 from the current reader module 306. The PWM limiter 308 limits the maximum PWM ratio command used to drive the motor 82 to prevent low voltage conditions on the power switching network 255 (e.g., gate drivers). The PWM ratio command limit is provided to the bus current controller 320.

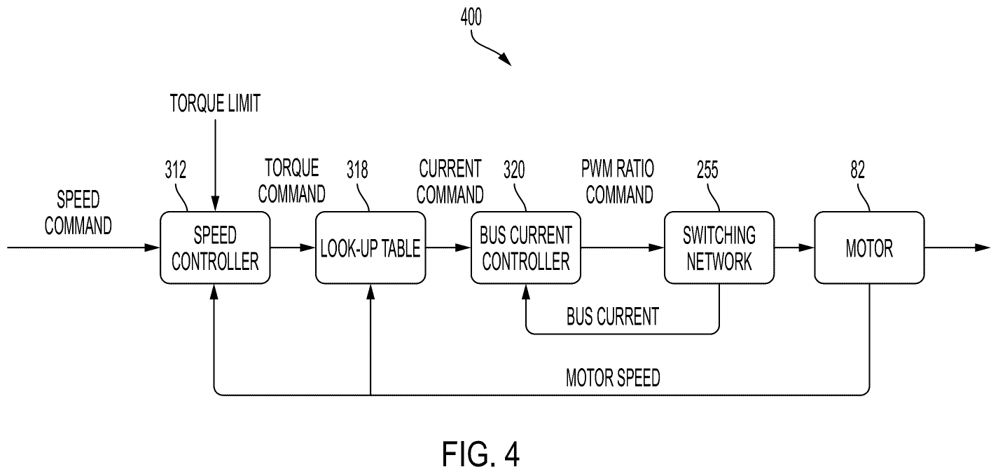

FIG. 4 provides a block diagram of a control block 400 for control of the motor 82. The speed controller 312 receives the motor speed or velocity from the velocity estimator module 302. Additionally, the speed controller 312 receives a speed command. For example, a default speed of the motor 82 may be selected. The speed controller 312 compares the motor speed provided by the velocity estimator module 302 with the speed command to determine a torque at which to drive the motor 82. For example, if the motor speed is less than the speed command, the speed controller 312 outputs a torque command (e.g., a torque value) to increase the speed of the motor 82. If the motor speed is greater than the speed command, the speed controller 312 outputs a torque command to decrease the speed of the motor 82. If the motor speed is equal to the speed command, the speed controller 312 outputs a torque command to maintain the speed of the motor 82.

The torque command and the motor speed are provided to the look-up table 318. The torque command and the motor speed are compared to the look-up table 318 to determine a current command, such as a current value or bus current value at which to drive the motor 82. The current command is provided to the bus current controller 320. The bus current controller 320 then compares the current command to the measured bus current (e.g., the measured current of the motor 82 as provided by the current reader module 306). The bus current controller 320 drives the power switching network 255 with a PWM ratio command (e.g., a PWM duty cycle ratio command) based on this comparison. For example, if the current command is less than the measured bus current, the bus current controller 320 decreases the PWM duty cycle at which the power switching network 255 is driven. If the current command is greater than the measured bus current, the bus current controller 320 increases the PWM duty cycle at which the power switching network 255 is driven. If the current command is equal to the measured bus current, the bus current controller 320 maintains the PWM duty cycle at which the power switching network 255 is driven.

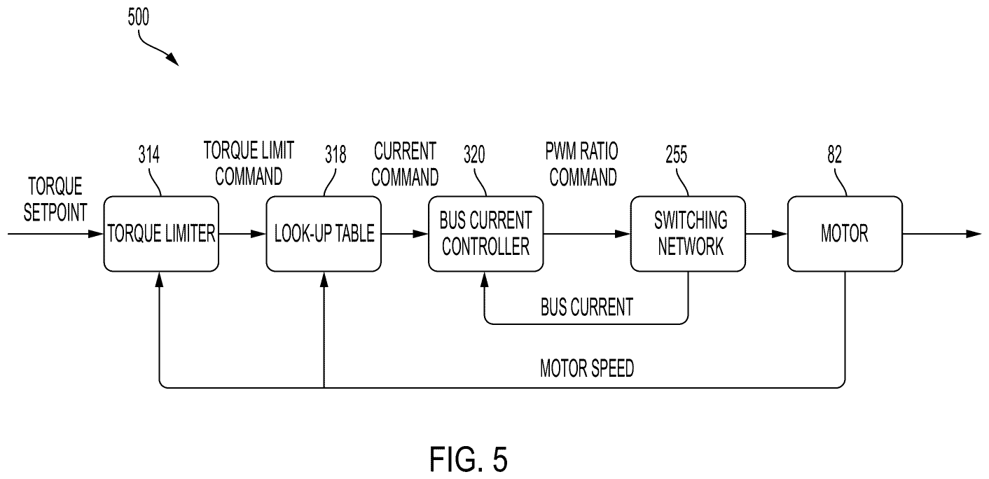

In some embodiments, the torque limiter module 314 limits the torque command provided by the speed controller 312. FIG. 5 provides a block diagram of a control block 500 for limiting the torque command. A torque setpoint is provided to the torque limiter module 314. For example, the torque setpoint may be provided by the input device 140.

In instances where, for example, the control architecture 300 is implemented in a power tool configured to drive a fastener, the torque limiter module 314 limits the torque based on, for example, an estimated absorption energy of the motor 82. The absorption energy is estimated based on the principle of balancing the mechanical flywheel energy of the motor 82 with the available absorption energy.

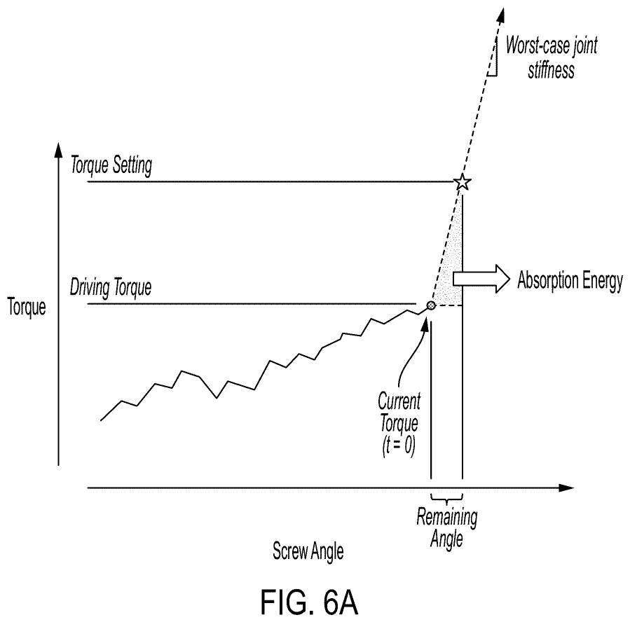

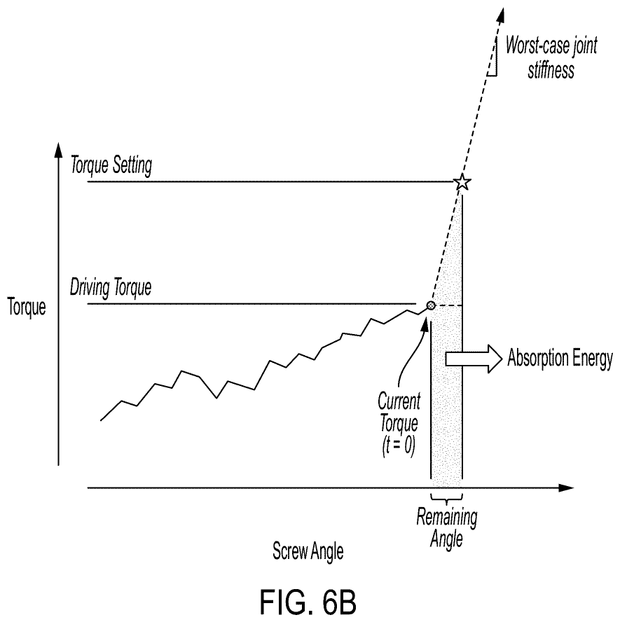

The absorption energy of the fastener is the integral of torque with respect to angle, and the net absorption energy of the fastener is the absorption energy minus the energy delivered by the torque of the motor 82. FIG. 6A provides an example of the absorption energy when the motor torque remains constant after joint. Equation 1 provides the absorption energy balanced with the flywheel energy:

$$\frac{1}{2} J {ω}^{2} = \frac{{( {T}_{s} - {T}_{d} )}^{2}}{2 {k}_{j o i n t}} \qquad [ Equation 1 ]$$

where:
J—inertia from the perspective of the motor (kg-m²)
ω—motor velocity (rad/s)
Tₛ—torque setpoint (Nm)
T_{d}—driving torque (Nm)
kⱼₒᵢₙₜ—joint stiffness (Nm/rad)

When the torque limit is set to the driving torque, Equation 1 can be rearranged such that the torque limit is set based on the motor speed, the torque setpoint, drill inertia, and joint stiffness, as shown in Equation 2:

Tₗᵢₘᵢₜ=T_{d}=Tₛ−\sqrt{Jkⱼₒᵢₙₜ}ω [Equation 2]

where:
Tₗᵢₘᵢₜ—torque limit (Nm)

In another example, all of the absorption energy of a fastener's joint is used to stop the motor 82. Accordingly, the motor 82 is de-energized the instant a joint is reached, and negative torque is introduced in applying a brake. FIG. 6B provides an example of the absorption energy when the motor 82 is de-energized. Equation 3 provides the absorption energy balanced with the flywheel energy.

$$\frac{1}{2} J {ω}^{2} = \frac{{T}_{s}^{2} - {T}_{d}^{2}}{2 {k}_{j o i n t}} \qquad [ Equation 3 ]$$

When the torque limit is set to the driving torque, Equation 3 can be rearranged such that the torque limit is set based on the motor speed, the torque setpoint, drill inertia, and joint stiffness, as shown in Equation 4:

Tₗᵢₘᵢₜ=T_{d}=\sqrt{Tₛ²−Jkⱼₒᵢₙₜω²} [Equation 4]

Returning to FIG. 3, if the torque command is greater than the torque limit, the torque limit is instead provided to the look-up table 318. Control of the motor 82 is then continued using the torque limit as the torque command, as shown in FIG. 5.

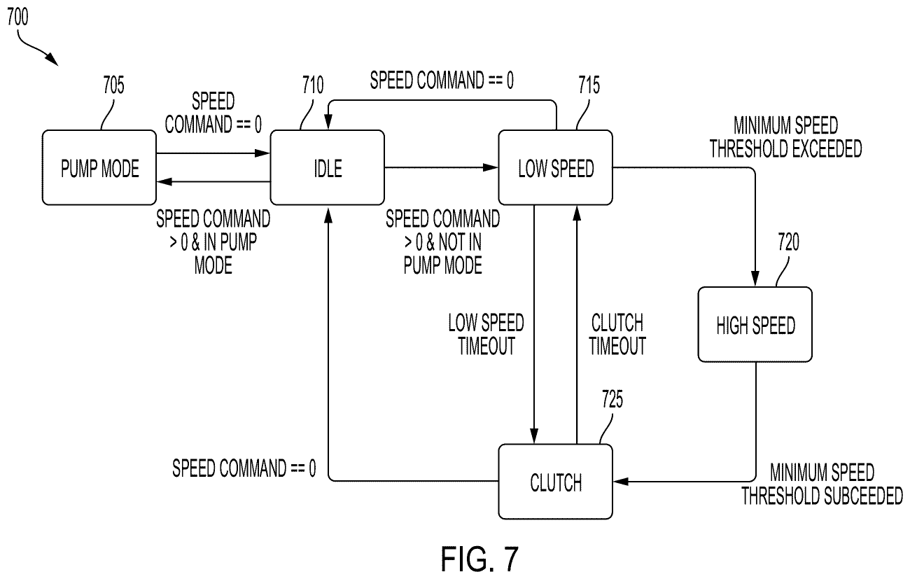

In some embodiments, the PWM ratio command provided by the bus current controller 320 is overridden by the braking control module 316. For example, based on the motor speed provided by the velocity estimator module 302, the braking control module 316 may determine to brake the motor 82. FIG. 7 provides a state diagram 700 illustrating operation of the pump 10, as performed by the controller 200.

When the speed command of the motor 82 is set to 0 (e.g., when the power switch 56 is not actuated), the controller 200 is in an idle mode (block 710). When in the idle mode, the controller 200 monitors for actuation of the power switch 56, and the power switching network 255 is placed in a high impedance state to prevent power transfer from the battery pack 50 to the motor 82. When the power switch 56 is actuated (e.g., the speed command is greater than 0), the controller 200 determines whether the pump 10 is in a pump mode. When in a pump mode, the controller 200 proceeds to block 705. In the pump mode, the speed of the motor 82 is controlled at the maximum torque limit of the motor 82. The maximum torque limit of the motor 82 may be, for example, stored in the memory 225, set by the input device 140, or the like. Pump mode may be set, for example, by the input device 140 on the pump 10. In some embodiments, when in the pump mode, the torque limiter module 314 is disabled.

When the pump 10 is not in a pump mode and the power switch 56 is actuated, the controller 200 proceeds to block 715 and operates the motor 82 according to a low speed mode (e.g., a first operating mode, a first speed setting). The low speed mode may be, for example, an operating mode associated with beginning of driving the motor 82 when the motor 82 was fully stopped. While in the low-speed mode, the controller 200 monitors the speed of the motor 82 as provided by the velocity estimator module 302. In some embodiments, while in the low-speed mode, the speed controller 312 is bypassed, and the motor 82 is controlled such that the torque output of the speed controller 312 is equal to the torque setpoint. If the speed of the motor 82 increases above or equal to a minimum speed threshold, the controller 200 proceeds to block 720. In some embodiments, the minimum speed threshold has a value of between 500 rotations per minute (“RPM”) and 3000 RPM. In some embodiments, the minimum speed threshold has a value of approximately 1800 RPM. However, if the speed of the motor 82 remains below the minimum speed threshold for a low speed timeout period (e.g., a first predetermined time period), the controller 200 instead proceeds to block 725. If the speed command is set to zero (0) at any point (e.g., the power switch 56 is de-actuated or actuated to an OFF position), the controller 200 transitions back to the idle mode (block 710).

When the speed of the motor 82 exceeds or is equal to the minimum speed threshold, the controller 200 proceeds to block 720 and operates in a high speed mode (e.g., a second operating mode, a second speed setting). While in the high speed mode, the controller 200 drives the motor 82 according to received speed commands while within the set torque limits. The speed controller 312 is active, and the torque limiter module 314 may limit the torque output of the speed controller 312, which may reduce speed for clutch settings or when a significant load is applied. For example, when a high load state is detected based on the speed of the motor 82, the torque output of the speed controller 312 is limited.

When the speed of the motor 82 drops below the minimum speed threshold while operating in the high speed mode, the controller 200 proceeds to block 725 and operates in a clutch mode. In some embodiments, hysteresis can be used such that different speed thresholds are used to control transitions from the low speed mode to the high speed mode and the high speed mode to the clutch mode. Additionally, when the controller 200 operates in the low speed mode (block 715) for a predetermined time period, the controller 200 proceeds to block 725 and operates in the clutch mode. While in the clutch mode, the controller 200 limits the current of the motor 82. For example, the current command provided to the bus current controller 320 by the look-up table 318 is overwritten by a low current command. This results in a zero torque value of the motor assembly 30, and emulates the sound a mechanical clutch makes when engaged (e.g., a ratcheting sound caused by switching between the low speed mode and the clutch mode). The low current command is maintained for a clutch timeout period, at which point the controller 200 returns to block 715 and operates in the low speed mode. If the power switch 56 is de-actuated while the controller 200 is in the clutch mode, the controller 200 returns to block 710 and operates in the idle mode. Additionally, in some instances, due to the clutch timeout period and the low speed timeout period, the controller 200 may alternate between the low speed mode at block 715 and the clutch mode at block 725 indefinitely (i.e., making the ratcheting sound) until the power switch 56 is de-actuated. In some embodiments, the clutch timeout period and the low speed timeout period have values between 5 milli-seconds and 100 milli-seconds. In some embodiments, the clutch timeout period and the low speed timeout period have values of approximately 35 milli-seconds.

Returning to FIG. 3, the field weakening module 322 is configured to improve torque capability at high speeds when the back-electromotive force (“EMF”) of the motor 82 causes the drive to become voltage limited. Field weakening may be applied by identifying the relationship between motor current, motor torque, and motor speed at a steady state. This relationship may be used to correct nominal field weakening. In some embodiments, the field weakening module 322 is disabled.

In instances where the control architecture 300 is implemented in a power tool that does not, for example, drive a fastener, such as the pump 10, the braking control module 316 may be disabled. In such instances, selected operating modes of the pump 10 may be configured to adjust the torque limit at torque limit module 314, thereby changing the load on the pump 10. For example, using the input device 140, an operator of the pump 10 may set the pump 10 to the idle mode, where the power switching network 255 is placed in a high impedance state to prevent power transfer from the battery pack 50 to the motor 82. In another example, an operator of the pump 10 sets, using the input device 140, the pump to a Full Power Mode, where the torque limiter module 314 is disabled. In a further example, an operator of the pump 10 sets, using the input device 140, the pump to an “Eco-Mode”, where the speed controller 312 requests current or torque up to only the allowed limit, as described below in more detail.

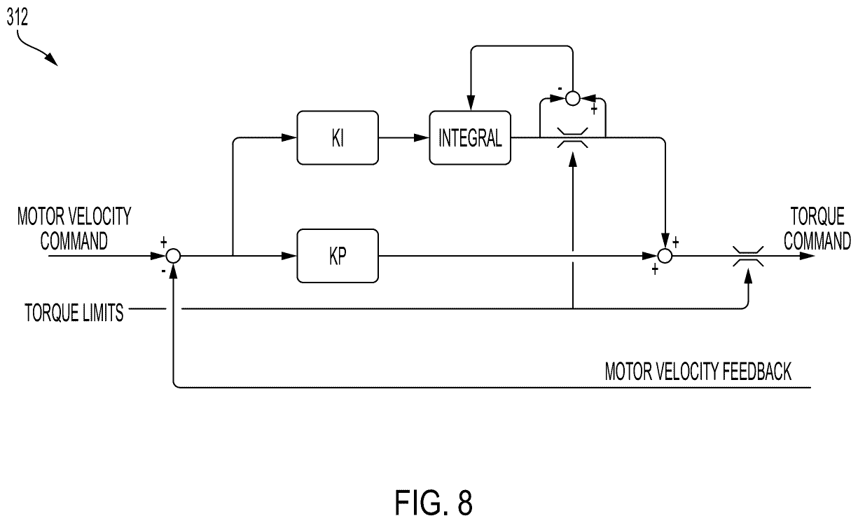

FIG. 8 illustrates an example block diagram of the speed controller 312. Equation 5 provides an example model for determining a torque command based on the motor speed:

$${T}_{C} + b ω + J \frac{d ω}{d L} = {T}_{drive} \qquad [ Equation 5 ]$$

Equation 6 provides a simplified transfer function of the model of Equation 5:

$$\frac{Ω ( s )}{{T}_{d r i v e} ( s )} = \frac{1}{Js + b} \qquad [ Equation 6 ]$$

The torque command output by the speed controller 312 is locked to the upper torque limit any time the controller 200 is operating in the low speed mode. When the controller 200 is in the clutch mode, the torque command is overwritten downstream. However, the speed controller 312 continues operation. The illustrated speed controller 312 includes two gains: a proportional gain K_{P} and an integral gain K_{I}.

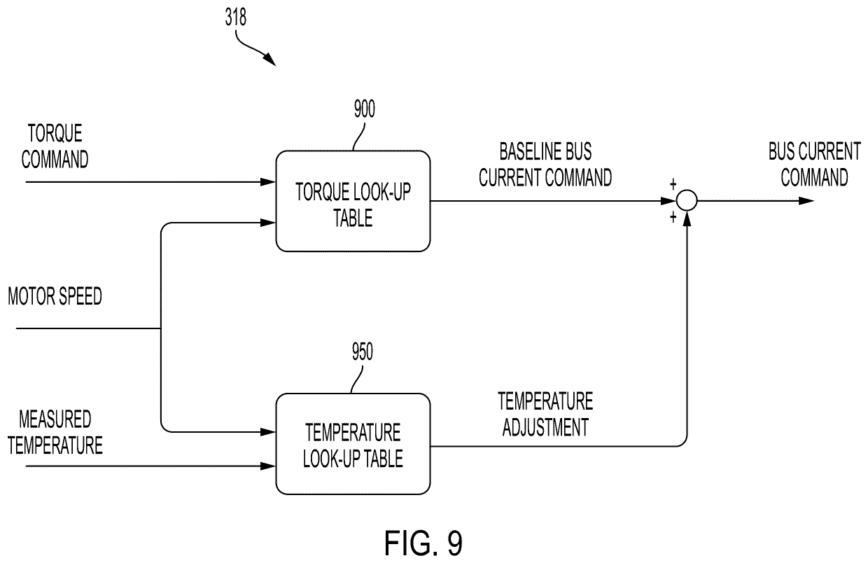

FIG. 9 illustrates an example block diagram of the look-up table 318. The torque command from the speed controller 312 is compared to the motor speed at a torque look-up table 900. The torque look-up table 900 (e.g., a torque-velocity-current look-up table) outputs a baseline bus current command. Additionally, the motor speed is compared to the measured temperature, as provided by the temperature reader module 304, at a temperature look-up table 950. The output of the temperature look-up table 950 is a temperature adjustment output. The temperature adjustment output is applied to the baseline bus current command to create the bus current command provided to the bus current controller 320.

In some embodiments, rather than using the look-up table 318, the torque command is converted to the bus current command using a slope-intercept method. The slope-intercept method converts torque to current independent of the motor speed and the temperature. For a given gear ratio, a slope and an intercept are provided to convert the torque to a current command.

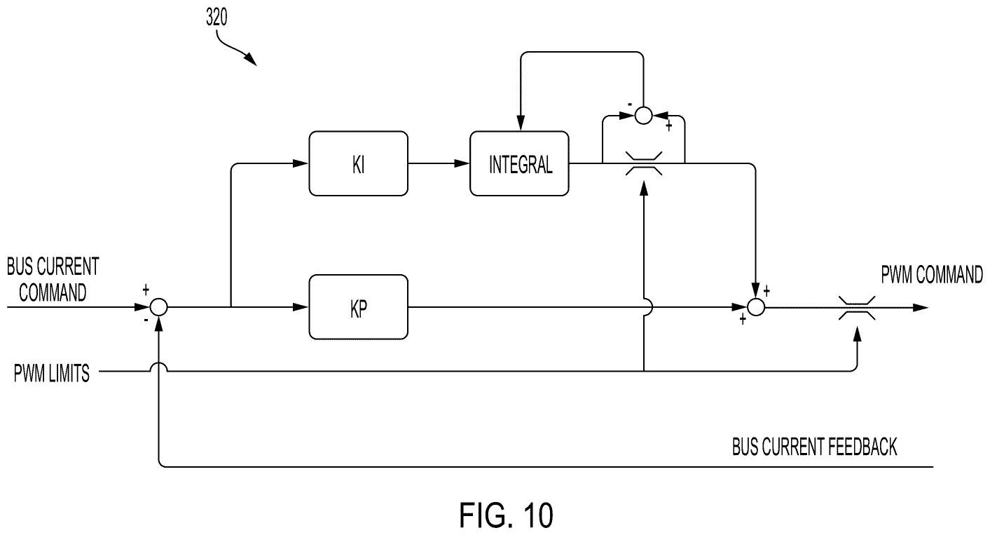

FIG. 10 illustrates an example block diagram of the bus current controller 320. The bus current controller 320 outputs a PWM ratio command signal based on the bus current command from the look-up table 318. Equation 7 provides an example model for determining a PWM ratio command signal based on the bus current:

$${R}_{e q} {i}_{batt} + {L}_{e q} \frac{d {i}_{b a t t}}{dt} + {K}_{e} ω = {V}_{batt} {d}_{P W M} \qquad [ Equation 7 ]$$

If velocity is constant relative to the electrodynamics and the battery voltage is constant, the model of Equation 7 becomes a transfer function defined by Equation 8:

$$\frac{{I}_{b a t t} ( s )}{{d}_{P W M} ( s )} = {V}_{batt} \frac{1}{{L}_{e q} s + {R}_{e q}} \qquad [ Equation 8 ]$$

When the controller 200 is operating in the low speed mode, the high speed mode, or the drill mode, the bus current controller 320 operates normally. When in the idle mode or when braking, the PWM ratio command output is overridden to zero. When in the clutch mode, the bus current command is overridden to another value to overcome cogging torque and reduce system backlash. Additionally, in some embodiments, when transitioning from the clutch mode to the low speed mode, the PWM ratio command is overwritten to a value that increases drill jerk to improve drill end indication user experience. Additionally, the bus current controller 320 may limit the PWM ratio command output to prevent bus current overshoot (e.g., an overcurrent condition). The illustrated current controller 320 includes two gains: a proportional gain K_{P} and an integral gain K_{I}.

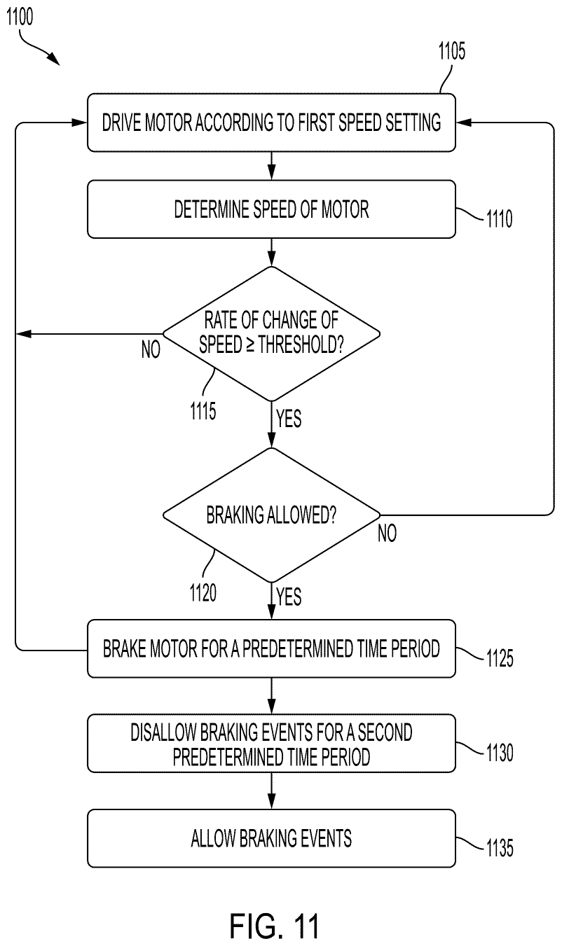

FIG. 11 provides a method 1100 for controlling the motor 82. The method 1100 may be performed by the controller 200. At block 1105, the controller 200 drives the motor 82 according to a first speed setting. For example, the controller 200 drives the motor 82 according to the high speed mode while receiving a speed command from the power switch 56. At block 1110, the controller 200 determines the speed of the motor 82. For example, in some embodiments, the controller 200 receives speed signals from the speed sensor 250 indicative of the speed of the motor 82. In other embodiments, the controller 200 determines the speed of the motor 82 based on current signals from the current sensor 270.

At block 1115, the controller 200 determines whether a rate of change of the speed of the motor 82 is greater than or equal to a speed drop threshold (e.g., a speed rate of change threshold, rate of speed loss threshold, rate of speed reduction threshold, etc.). If the rate of change of the speed of the motor 82 is less than the speed drop threshold, the controller 200 returns to block 1105 and continues to drive the motor 82 according to the first speed setting. For example, the speed of the motor 82 experiences minor variations in speed. If the rate of change of the speed of the motor 82 is greater than or equal to the speed threshold (for example, a reduction in speed of 400-600 RPM over a 10 ms period of time), the controller 200 proceeds to block 1120. In some embodiments, the speed drop threshold corresponds to a change in rotations per minute (“RPM”) of between 100 RPM and 2000 RPM during the first time period. In some embodiments, the speed drop threshold corresponds to a change in RPM of approximately 400 RPM during the first time period. In some embodiments, the controller 200 monitors the speed of the motor 82 over a first period of time to determine the rate of change, such as between 5 milli-seconds and 100 milli-seconds. In some embodiments, the first period of time is approximately 10 milli-seconds.

At block 1120, the controller 200 determines whether braking of the motor 82 is allowed. For example, to prevent false braking triggers, braking of the motor 82 may be disallowed for a predetermined period of time after a braking event is completed, as braking causes deceleration of the motor that may result in a reduction of speed that satisfies the speed drop threshold a second time. By disallowing recurrent braking events, the controller 200 avoids false braking events. If braking events are not allowed, the controller returns to block 1105 and continues to drive the motor 82 according to the first speed setting. If braking events are allowed, the controller proceeds to block 1125. In some embodiments, braking events are not disallowed, and block 1120 (and blocks 1130 and 1135) may be removed from the method 1100.

At block 1125, the controller 200 brakes the motor 82 for a predetermined time period. For example, the controller 200 controls the power switching network 255 to electronically brake the motor 82. Once the predetermined period of time is satisfied, the controller 200 disallows braking events (at block 1130) and returns to block 1105. The controller 200 disallows braking events for a second predetermined time period to prevent false braking triggers. Once the second predetermined time period is satisfied, the controller 200 allows braking events to be performed (at block 1135). In some embodiments, braking is disabled at low speeds (e.g., 2000 RPM or fewer).

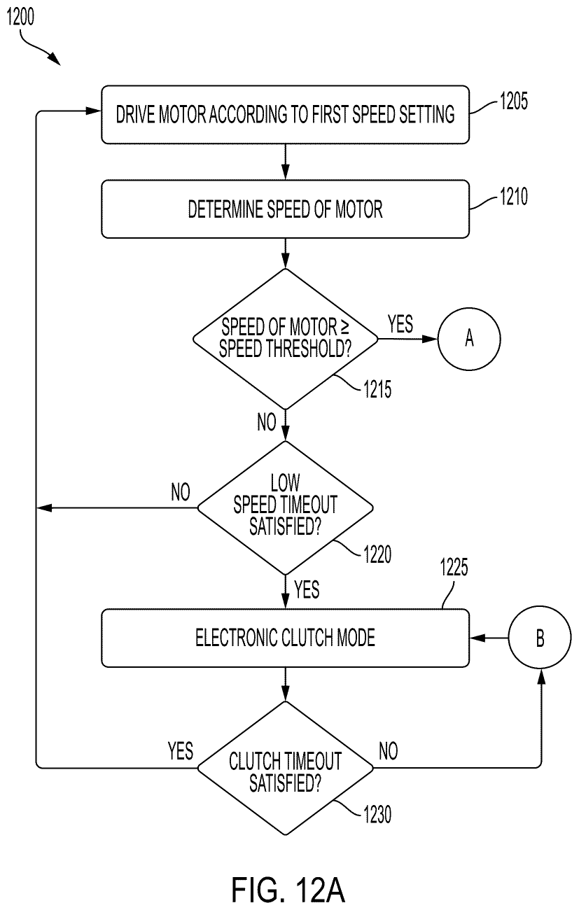

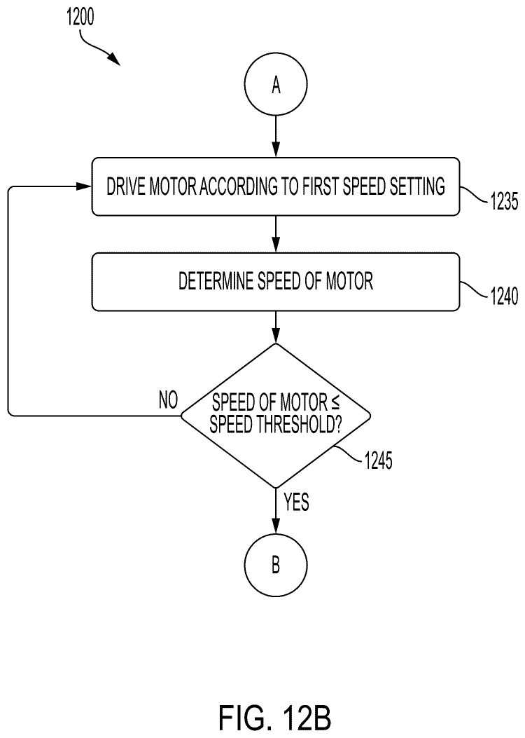

FIGS. 12A-12B provide a method 1200 for controlling the motor 82. The method 1200 may be performed by the controller 200. The method 1200 may be performed in parallel to the method 1100 of FIG. 11. At block 1205, the controller 200 drives the motor 82 according to a first speed setting. For example, the controller 200 drives the motor 82 according to the low speed mode while receiving a speed command from the power switch 56. At block 1210, the controller 200 determines the speed of the motor 82. For example, in some embodiments, the controller 200 receives speed signals from the speed sensor 250 indicative of the speed of the motor 82. In other embodiments, the controller 200 determines the speed of the motor 82 based on current signals from the current sensor 270.

At block 1215, the controller 200 determines whether the speed of the motor 82 is greater than or equal to a speed threshold. If the speed of the motor 82 is greater than or equal to the speed threshold, the controller 200 proceeds to block 1235 (see FIG. 12B). If the speed of the motor 82 is less than the speed threshold, the controller 200 determines whether the low speed timeout threshold has been satisfied (block 1220). If the low speed timeout threshold is not satisfied, the controller 200 returns to block 1205 and continues to drive the motor 82 according to the first speed setting.

If the low speed timeout threshold is satisfied, the controller 200 proceeds to block 1225 and enters the electronic clutch mode. In the electronic clutch mode, the controller 200 drives the motor 82 according to a low current command, as previously described. At block 1230, the controller 200 determines whether the clutch timeout period is satisfied. If the clutch timeout period is satisfied, the controller 200 returns to block 1205 and drives the motor 82 according to the first speed setting. If the clutch timeout period is not satisfied, the controller 200 returns to block 1225 and continues to operate in the electronic clutch mode. In some embodiments, the clutch timeout period corresponds to between 10 and 100 milli-seconds. In some embodiments, the clutch timeout period is approximately 35 milli-seconds.

Returning to block 1215, if the speed of the motor is greater than or equal to the speed threshold, the controller 200 proceeds to block 1235. At block 1235, the controller 200 drives the motor 82 according to a second speed setting. In some embodiments, the second speed setting is the high speed mode. At block 1240, the controller 200 determines the speed of the motor 82. For example, in some embodiments, the controller 200 receives speed signals from the speed sensor 250 indicative of the speed of the motor 82. In other embodiments, the controller 200 determines the speed of the motor 82 based on current signals from the current sensor 270.

At block 1245, the controller 200 determines whether the speed of the motor 82 is less than or equal to the speed threshold. If the speed of the motor 82 is greater than the speed threshold, the controller 200 continues to drive the motor 82 according to the second speed setting. If the speed of the motor 82 is less than or equal to the speed threshold, the controller 200 proceeds to block 1225 and enters the electronic clutch mode. For example, the method 1100 in FIG. 11 can cause a rapid slowdown of the motor 82 that causes the motor speed to become less than the speed threshold and the transition from the second speed setting to the electronic clutch mode.

In some instances, the pump 10 is capable of operating in a plurality of operating modes. For example, while operating in one operating mode, the speed controller 312 receives the speed command, the motor speed, and the torque limit to output a torque command, as previously illustrated in FIG. 4. In another operating mode, the torque limit is adjusted to a lower value (e.g., a second torque limit, a second torque threshold), further limiting the output torque of the motor 82. In yet another operating mode, rather than receiving a torque limit to output a torque command, the speed controller 312 receives a current threshold and provides a current command, bypassing the torque control and look-up table 318.

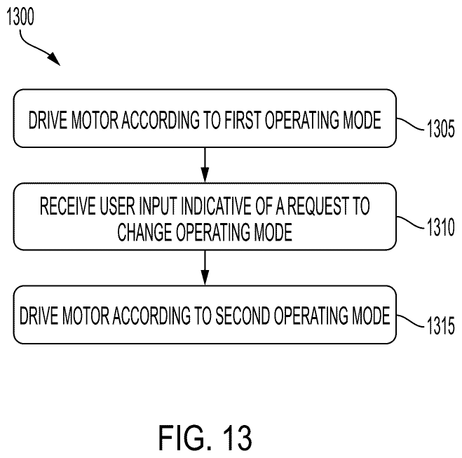

FIG. 13 provides a method 1300 for switching between operating modes of the pump 10. The method 1300 may be performed by the controller 200. At block 1305, the controller 200 drives the motor 82 according to a first operating mode (e.g., a speed-torque closed loop control). For example, while in the first operating mode, the controller 200 receives a speed command (e.g., actuation of the power switch 56), a speed of the motor 82, and a torque limit. The controller 200 determines a torque command based on the speed command, the speed of the motor 82, and the torque limit, as described with respect to FIG. 4.

At block 1310, the controller 200 receives a user input indicative of a request to change an operating mode of the pump 10. For example, the controller 200 receives a user input via the input device 140. At block 1315, the controller 200 drives the motor 82 according to a second operating mode (e.g., a speed-current closed loop control). In the second operating mode, the speed controller 312 receives current signals from the current sensor 270 indicative of the current of the motor 82. Additionally, the speed controller 312 receives speed signals from the speed sensor 250 indicative of a speed of the motor 82. The speed controller 312 then generates a torque or current command based on the current of the motor 82 and the speed of the motor 82. In some embodiments, the speed controller 312 compares the current of the motor 82 to a current threshold.

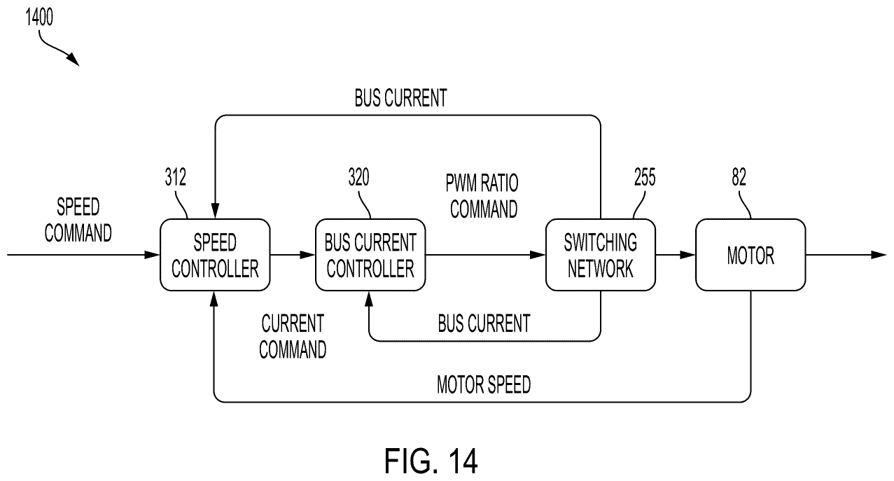

FIG. 14 provides a block diagram of a control block 1400 for control of the motor 82 in the second operating mode (e.g., the speed-current closed loop control mode). As seen in FIG. 14, the speed controller 312 receives the measured bus current from the current sensor 270 (measured at the power switching network 255). The speed controller 312 also receives a speed command and the detected speed of the motor 82. In some embodiments, rather than receiving a torque limit, the speed controller 312 receives (or stores in a memory) a current threshold. The speed controller 312 outputs a current command based on the speed command, the motor speed, and the bus current. Should the current command exceed the current threshold, the speed controller 312 provides the current threshold value as the current command.

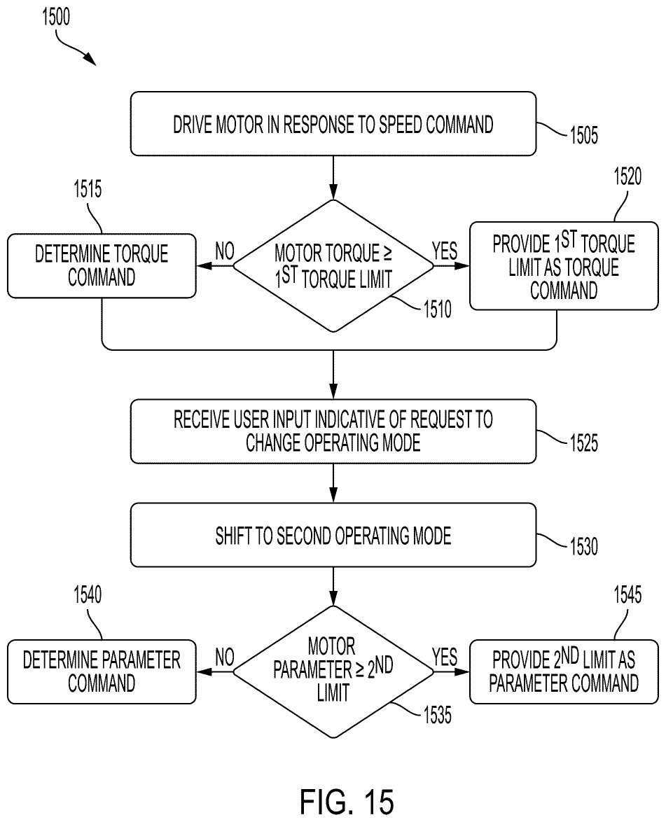

FIG. 15 provides another method 1500 for switching between operating modes of the pump 10. The method 1500 may be performed by the controller 200. At block 1505, the controller 200 drives the motor 82 in response to a received speed command. For example, the controller 200 drives the motor 82 in response to actuation of the power switch 56. At block 1510, the controller 200 determines whether the torque of the motor 82 is greater than or equal to a first torque limit (e.g., a first torque threshold). When the torque of the motor 82 is less than the first torque limit, the controller 200 proceeds to block 1515 and determines a torque command used to drive the motor 82 based on the speed of the motor 82. When the torque of the motor 82 is greater than or equal to the first torque limit, the controller 200 proceeds to block 1520 and provides the first torque limit as the torque command used to drive the motor 82.

At block 1525, the controller 200 receives a user input indicative of a request to change an operating mode of the pump 10. For example, the controller 200 receives a user input via the input device 140. At block 1530, the controller 200 shifts the pump 10 to a second operating mode. In the second operating mode, the controller 200 implements a second parameter limit (e.g., a second torque or current limit or threshold) having a value less than, for example, the first torque limit. At block 1535, the controller 200 determines whether a parameter (e.g., torque, current, etc.) of the motor 82 is greater than or equal to the second parameter limit. When the parameter of the motor 82 is less than the second limit, the controller 200 proceeds to block 1540 and determines a parameter command (e.g., torque or current command) used to drive the motor 82 based on the speed of the motor 82. When the parameter of the motor 82 is greater than or equal to the second limit, the controller 200 proceeds to block 1545 and provides the second parameter limit (e.g., torque or current limit) as the parameter command used to drive the motor 82.

In some embodiments, the speed-current closed loop control mode described with respect to FIG. 14 and the second parameter limit mode described with respect to FIG. 15 are alternative “Eco-Modes” of the pump 10. While in an Eco-Mode, if the pump 10 is permitted enough torque or current to achieve maximum speed, maximum speed is still achieved. However, if the pump 10 operates at maximum permitted torque or maximum permitted current in the Eco-Mode, the speed of the motor 82 is reduced to conserve energy. When an Eco-Mode is initiated (for example, via the input device 140), the speed controller 312 requests current or torque up to only the allowed limit, and the pump 10 slows down to reduce the load. As the load on the pump 10 decreases, the speed of the motor 82 inherently increases until the motor 82 reaches the speed indicated by the speed command.

### REPRESENTATIVE FEATURES

Representative features are set out in the following clauses, which stand alone or may be combined, in any combination, with one or more features disclosed in the text and/or drawings of the specification.

1. A power tool including an electronic clutch, the power tool comprising:
a motor;
a power switch;
a speed sensor configured to sense a speed of the motor; and
a controller connected to the power switch, the motor, and the speed sensor, the controller configured to:
   provide, in response to actuation of the power switch, power to the motor,
   determine a first parameter command based on the speed of the motor,
   determine, while in a first operating mode, whether the first parameter command is greater than or equal to a first parameter limit,
   determine, while in the first operating mode and when the first parameter command is greater than or equal to the first parameter limit, a pulse width modulation (“PWM”) duty cycle ratio based on the first parameter limit,
   determine, while in a second operating mode, whether a second parameter command is greater than or equal to a second parameter limit,
   determine, while in the second operating mode and when the second parameter command is greater than or equal to the second parameter limit, the PWM duty cycle ratio based on the second parameter limit, and
   drive the motor based on the PWM duty cycle ratio.
      2. The power tool of clause 1, wherein:
the first parameter command is one of a first torque command or a first current command; and
the second parameter command is one of a second torque command or a second current command.
   3. The power tool of any preceding clause, wherein the controller is further configured to:
determine, based on the speed of the motor and a speed command signal, the first parameter command;
compare the first parameter command to a torque-current look-up table;
determine, based on the comparison, an electric current value to provide to the motor; and
provide the electric current value to the motor to drive the motor.
   4. The power tool of clause 3, further comprising:
a current sensor configured to provide current signals indicative of a current of the motor,
wherein the controller is further configured to:
   receive, from the current sensor, the current signals indicative of the current of the motor,
determine the PWM duty cycle ratio based on the current of the motor and the electric current value, and
   drive the motor according to the PWM duty cycle ratio.
      5. The power tool of any preceding clause, wherein the controller is further configured to:
control, in response to actuation of the power switch, the motor according to the first operating mode for a third period of time.
   6. The power tool of clause 5, wherein the controller is further configured to:
limit, in response to the third period of time being satisfied, a motor current provided to the motor for a fourth period of time.
7. The power tool of clause 6, wherein the controller is further configured to:
control, in response to the fourth period of time being satisfied, the motor according to the first operating mode.
   8. The power tool of any preceding clause, wherein the controller is further configured to:
determine, while in the first operating mode and when the first parameter command is less than the first parameter limit, the PWM duty cycle ratio based on the first parameter command, and
determine, while in the second operating mode and when the second parameter command is less than the second parameter limit, the PWM duty cycle ratio based on the second parameter command.
   9. A method for operating a power tool including an electronic clutch, the method comprising:
providing, in response to actuation of a power switch, power to a motor;
determining a first parameter command based on a speed of the motor;
determining, while in a first operating mode, whether the first parameter command is greater than or equal to a first parameter limit;
determining, while in the first operating mode and when the first parameter command is greater than or equal to the first parameter limit, a pulse width modulation (“PWM”) duty cycle ratio based on the first parameter limit;
determining, while in a second operating mode, whether a second parameter command is greater than or equal to a second parameter limit;
determining, while in the second operating mode and when the second parameter command is greater than or equal to the second parameter limit, the PWM duty cycle ratio based on the second parameter limit; and
drive the motor based on the PWM duty cycle ratio.
   10. The method of clause 9, wherein:
the first parameter command is one of a first torque command or a first current command; and
the second parameter command is one of a second torque command or a second current command.
   11. The method of any of clauses 9-10, further comprising:
determining, based on the speed of the motor and a speed command signal, the first parameter command;
comparing the first parameter command to a torque-current look-up table;
determining, based on the comparison, an electric current value to provide to the motor; and
providing the electric current value to the motor to drive the motor.
   12. The method of clause 11, further comprising:
receiving current signals indicative of the current of the motor,
   determining the PWM duty cycle ratio based on the current of the motor and the electric current value, and
   driving the motor according to the PWM duty cycle ratio.
      13. The method of any of clauses 9-12, further comprising:
controlling, in response to actuation of the power switch, the motor according to the first operating mode for a third period of time;
limiting, in response to the third period of time being satisfied, a motor current provided to the motor for a fourth period of time; and
controlling, in response to the fourth period of time being satisfied, the motor according to the first operating mode.
   14. The method of any of clauses 9-13, further comprising:
determining, while in the first operating mode and when the first parameter command is less than the first parameter limit, the PWM duty cycle ratio based on the first parameter command; and
determining, while in the second operating mode and when the second parameter command is less than the second parameter limit, the PWM duty cycle ratio based on the second parameter command.
   15. A power tool including an electronic clutch, the power tool comprising:
a motor;
a speed sensor configured to sense a speed of the motor;
a current sensor configured to sense a current of the motor; and
a controller connected to the motor, the speed sensor, and the current sensor the controller configured to:
   drive, while in a first operating mode, the motor based on the speed of the motor and a torque limit value,
   receive a user input indicative of a request to operate in a second operating mode, and
   drive, while in the second operating mode, the motor based on the speed of the motor and the current of the motor.
      16. The power tool of clause 15, wherein the controller is further configured to:
determine, while in the first operating mode, a torque command based on a speed command and the speed of the motor;
determine, while in the first operating mode, whether the torque command is greater than or equal to the torque limit value;
determine, while in the first operating mode and when the torque command is greater than or equal to the torque limit value, a pulse width modulation (“PWM”) duty cycle ratio based on the first torque limit; and
drive the motor based on the PWM duty cycle ratio.
   17. The power tool of any of clauses 15-16, wherein the controller is further configured to:
determine, while in the second operating mode, a current command based on a speed command, the speed of the motor, and the current of the motor;
determine, while in the second operating mode, whether the current command is greater than or equal to a current threshold;
determine, while in the second operating mode and when the current command is greater than or equal to the current threshold, a pulse width modulation (“PWM”) duty cycle ratio based on the current threshold, and
drive the motor based on the PWM duty cycle ratio.
   18. The power tool of clause 17, wherein the controller is further configured to:
determine, while in the second operating mode and when the current command is less than the current threshold, the PWM duty cycle ratio based on the speed of the motor and the current of the motor; and
   drive the motor based on the PWM duty cycle ratio.
      19. The power tool of any of clauses 15-18, wherein, while in the first operating mode, the controller is further configured to:
determine, based on the speed of the motor and a speed command signal, a torque command;
compare the torque command to a torque-current look-up table;
determine, based on the comparison, an electric current value to provide to the motor; and
provide the electric current value to the motor to drive the motor.
   20. The power tool of any of clauses 15-19, wherein the controller is further configured to:
control, in response to actuation of a power switch, the motor according to the first operating mode for a first period of time;
limit, in response to the first period of time being satisfied, a motor current provided to the motor for a second period of time; and
control, in response to the second period of time being satisfied, the motor according to the first operating mode.

Thus, embodiments provided herein describe, among other things, systems and methods for switching between operating modes of an electronic clutch in a power tool. Various features and advantages are set forth in the following claims.

What is claimed is:

1. A power tool including an electronic clutch, the power tool comprising:
a motor;
a power switch;
a speed sensor configured to sense a speed of the motor; and
a controller connected to the power switch, the motor, and the speed sensor, the controller configured to:
provide, in response to actuation of the power switch, power to the motor,
determine a first parameter command based on the speed of the motor,
determine, while in a first operating mode, whether the first parameter command is greater than or equal to a first parameter limit,
determine, while in the first operating mode and when the first parameter command is greater than or equal to the first parameter limit, a pulse width modulation (“PWM”) duty cycle ratio based on the first parameter limit,
determine, while in a second operating mode, whether a second parameter command is greater than or equal to a second parameter limit,
determine, while in the second operating mode and when the second parameter command is greater than or equal to the second parameter limit, the PWM duty cycle ratio based on the second parameter limit, and
drive the motor based on the PWM duty cycle ratio.

2. The power tool of claim 1, wherein:
the first parameter command is one of a first torque command or a first current command; and
the second parameter command is one of a second torque command or a second current command.

3. The power tool of claim 1, wherein the controller is further configured to:
determine, based on the speed of the motor and a speed command signal, the first parameter command;
compare the first parameter command to a torque-current look-up table;
determine, based on the comparison, an electric current value to provide to the motor; and
provide the electric current value to the motor to drive the motor.

4. The power tool of claim 3, further comprising:
a current sensor configured to provide current signals indicative of a current of the motor,
wherein the controller is further configured to:
receive, from the current sensor, the current signals indicative of the current of the motor,
determine the PWM duty cycle ratio based on the current of the motor and the electric current value, and
drive the motor according to the PWM duty cycle ratio.

5. The power tool of claim 1, wherein the controller is further configured to:
control, in response to actuation of the power switch, the motor according to the first operating mode for a third period of time.

6. The power tool of claim 5, wherein the controller is further configured to:
limit, in response to the third period of time being satisfied, a motor current provided to the motor for a fourth period of time.

7. The power tool of claim 6, wherein the controller is further configured to:
control, in response to the fourth period of time being satisfied, the motor according to the first operating mode.

8. The power tool of claim 1, wherein the controller is further configured to:
determine, while in the first operating mode and when the first parameter command is less than the first parameter limit, the PWM duty cycle ratio based on the first parameter command, and
determine, while in the second operating mode and when the second parameter command is less than the second parameter limit, the PWM duty cycle ratio based on the second parameter command.

9. A method for operating a power tool including an electronic clutch, the method comprising:
providing, in response to actuation of a power switch, power to a motor;
determining a first parameter command based on a speed of the motor;
determining, while in a first operating mode, whether the first parameter command is greater than or equal to a first parameter limit;
determining, while in the first operating mode and when the first parameter command is greater than or equal to the first parameter limit, a pulse width modulation (“PWM”) duty cycle ratio based on the first parameter limit;
determining, while in a second operating mode, whether a second parameter command is greater than or equal to a second parameter limit;
determining, while in the second operating mode and when the second parameter command is greater than or equal to the second parameter limit, the PWM duty cycle ratio based on the second parameter limit; and
drive the motor based on the PWM duty cycle ratio.

10. The method of claim 9, wherein:
the first parameter command is one of a first torque command or a first current command; and
the second parameter command is one of a second torque command or a second current command.

11. The method of claim 9, further comprising:
determining, based on the speed of the motor and a speed command signal, the first parameter command;
comparing the first parameter command to a torque-current look-up table;
determining, based on the comparison, an electric current value to provide to the motor; and
providing the electric current value to the motor to drive the motor.

12. The method of claim 11, further comprising:
receiving current signals indicative of the current of the motor,
determining the PWM duty cycle ratio based on the current of the motor and the electric current value, and
driving the motor according to the PWM duty cycle ratio.

13. The method of claim 9, further comprising:
controlling, in response to actuation of the power switch, the motor according to the first operating mode for a third period of time;
limiting, in response to the third period of time being satisfied, a motor current provided to the motor for a fourth period of time; and
controlling, in response to the fourth period of time being satisfied, the motor according to the first operating mode.

14. The method of claim 9, further comprising:
determining, while in the first operating mode and when the first parameter command is less than the first parameter limit, the PWM duty cycle ratio based on the first parameter command; and
determining, while in the second operating mode and when the second parameter command is less than the second parameter limit, the PWM duty cycle ratio based on the second parameter command.

15. A power tool including an electronic clutch, the power tool comprising:
a motor;
a speed sensor configured to sense a speed of the motor;
a current sensor configured to sense a current of the motor; and
a controller connected to the motor, the speed sensor, and the current sensor the controller configured to:
drive, while in a first operating mode, the motor based on the speed of the motor and a torque limit value,
receive a user input indicative of a request to operate in a second operating mode, and
drive, while in the second operating mode, the motor based on the speed of the motor and the current of the motor.

16. The power tool of claim 15, wherein the controller is further configured to:
determine, while in the first operating mode, a torque command based on a speed command and the speed of the motor;
determine, while in the first operating mode, whether the torque command is greater than or equal to the torque limit value;
determine, while in the first operating mode and when the torque command is greater than or equal to the torque limit value, a pulse width modulation (“PWM”) duty cycle ratio based on the first torque limit; and
drive the motor based on the PWM duty cycle ratio.

17. The power tool of claim 15, wherein the controller is further configured to:
determine, while in the second operating mode, a current command based on a speed command, the speed of the motor, and the current of the motor;
determine, while in the second operating mode, whether the current command is greater than or equal to a current threshold;
determine, while in the second operating mode and when the current command is greater than or equal to the current threshold, a pulse width modulation (“PWM”) duty cycle ratio based on the current threshold, and
drive the motor based on the PWM duty cycle ratio.

18. The power tool of claim 17, wherein the controller is further configured to:
determine, while in the second operating mode and when the current command is less than the current threshold, the PWM duty cycle ratio based on the speed of the motor and the current of the motor; and
drive the motor based on the PWM duty cycle ratio.

19. The power tool of claim 15, wherein, while in the first operating mode, the controller is further configured to:
determine, based on the speed of the motor and a speed command signal, a torque command;
compare the torque command to a torque-current look-up table;
determine, based on the comparison, an electric current value to provide to the motor; and
provide the electric current value to the motor to drive the motor.

20. The power tool of claim 15, wherein the controller is further configured to:
control, in response to actuation of a power switch, the motor according to the first operating mode for a first period of time;
limit, in response to the first period of time being satisfied, a motor current provided to the motor for a second period of time; and
control, in response to the second period of time being satisfied, the motor according to the first operating mode.
